(19) United States
(12) Patent Application Publication
(10) Pub. No.: US 2018/0044527 A1
(43) Pub. Date: Feb. 15, 2018

(54) Two new methods to process natural asphalts which are thermoplastic and coalescent in nature found in deposits worldwide, including those at La Brea, Trinidad, West Indies, and at Guanaco, Sucre State, Venezuela. Either with no additive, or with only water which is later removed, powders and pellets are processed which are neither thermoplastic nor coalescence, are of the same composition and performance as the refined asphalts, thereby gaining the decades of goodwill of refined asphalts.

(71) Applicant: Anand Mungalsingh, Maraval (TT)

(72) Inventor: Anand Mungalsingh, Maraval (TT)

(21) Appl. No.: 15/234,225

(22) Filed: Aug. 11, 2016

(51) Int. Cl. C08L 95/00; C08J 3/12

(52) U.S. Cl. CPC C08L 95/00; C08J 3/12; C08L 95/005; C08J 2395/00

(57) ABSTRACT

Some natural asphalts deposits, like those in Trinidad and Venezuela, are thermoplastic and coalescent in nature. After removing the water content, the resulting refined asphalt flows, coalesces, and its mineral matter sediments in blends with refinery bitumen. Packaged in 250 kg coated kegs and barrels, specialized road-paving equipment are required for use. However, in this patent, two new methods are presented to solve these problems. In Method One, the natural asphalts are processed with or without additive so that the powders and pellets could be used on conventional equipment. In Method Two, the natural or refined asphalts are blended with water, producing powders and pellets which do not flow or coalesce. In all methods, the processed asphalts are packaged in bags, used on conventional road-paving equipment producing mixes without any additive, and with no adverse effect in performance.

### CROSS-REFERENCE TO RELATED APPLICATIONS

Not Applicable.

### BACKGROUND OF THE INVENTION

### 1. Introduction:

(a) The natural asphalt found at La Brea, Trinidad, West Indies, is known as Trinidad Natural Asphalt, or TNA. When the water in TNA is removed, refined Trinidad Lake Asphalt, or TLA, is obtained. Both TNA and TLA are thermoplastic in nature, acting as both a solid and a liquid. TNA and TLA are also coalescent in nature, so that the discrete elements of TNA or TLA easily coalesce. For many decades, this form of TLA is packaged in silicone-coated hardboard kegs, and this practice continues today.

(b) The natural asphalt found at Guanoco Lake, Sucre State, Venezuela, is known as Venezuela Natural Asphalt, or VNA. When the water in VNA is removed, refined Venezuela Lake Asphalt, or VLA, is obtained. During the last few years of production, this form of VLA was packaged in wooden barrels coated with releasing agents.

Like TNA and TLA, VNA and VLA are also thermoplastic and coalescent in nature.

(c) There are other natural asphalts available worldwide with a composition of water, bitumen and mineral matter, and which are also thermoplastic and coalescent in nature, and these asphalts are here termed NNA. When the water in NNA is removed, a refined form of the natural asphalts is produced, and this form is here termed as refined Natural Lake Asphalt, or NLA.

Like TNA and TLA, and like VNA and VLA, NNA and NLA are also thermoplastic and coalescent in nature.

### 2. The Clarifications.

(a) These deposits of natural asphalts available worldwide, which are thermoplastic and coalescent in nature, are not to be confused with the world's many deposits of tar sands, or tar pits. The compositions of natural asphalts and tar sands/tar pits are very different (natural asphalts have high bitumen content, usually above 40% by weight, whilst tar sands/tar pits have low bitumen content, usually below 22% by weight), and so too are the uses (natural asphalts have been used for decades as a modifier for road-paving, coatings, etc., whilst tar sands/tar pits have been used mainly to extract the bitumen content);
(b) The word ‘asphalt’ in this patent refers to the material found in natural asphaltic deposits worldwide (like in Trinidad, Venezuela, Iran, etc.), and do not refer to the asphalt or bitumen processed from crude oil at refineries;
(c) Further, the natural asphalts found in deposits which are thermoplastic and coalescent in nature, such as TNA or VNA or NNA, are referred to in this patent as “natural asphalts”.

When the water in the natural asphalts is removed, the resulting products, such as TLA or VLA or NLA, are referred to in this patent as “refined asphalts”.

When the natural asphalts are processed using no additives, or with water as the only additive, the water (i.e. natural water content and/or surface water) is then removed, the processed asphalts are then packaged and used, as is detailed in Sections 4 and 6 below, the resulting products, such as pTLA or pVLA or pNLA, are all referred in this patent as “processed asphalts”; and

(d) The phase “conventional road-paving equipment” in this patent refers to all road-paving equipment which do not include specialized heated tanks with stirrers to handle natural or refined or processed asphalts.
3. The Compositions of Two Natural Asphalts (i.e. TNA and VNA) by Weight are:

The compositions of TNA and VNA (as found in the deposits) are:

(a) TNA: Water: 30%, bitumen: 40%, mineral matter: 30%.
(b) VNA: Water: 15%, bitumen: 77%, mineral matter: 8%.

This composition of VNA varies slightly throughout the deposit.

4. The Chemistry of Two Refined Asphalts (i.e. TLA and VLA) Usually Includes:

Some chemistry of TLA and VLA (after the water content has been removed) are:

(a) TLA: (by weight) Bitumen: 54%, mineral matter: 46%.

The softening point: 101° C.

(b) VLA: (by weight) Bitumen: 91%, mineral matter: 9%.

The softening point: 106° C.

### 5. The Characteristics of Natural and Refined Asphalts.

These natural asphalts (such as TNA, VNA, and NNA) are thermoplastic in nature (i.e. solids that act like liquids). The higher the temperature, the more fluid are these natural asphalts. These natural asphalts are also coalescent in nature (i.e. discrete elements which coalesce).

All the refined asphalts (such as TLA, VLA and NLA) are also thermoplastic and coalescent in nature.

Throughout the decades, some natural asphalts (including TNA and VNA) have been processed by removing the water content, resulting in the refined asphalts (i.e. TLA and VLA). Refined asphalts are used as modifiers for road paving for decades.

The two main problems with refined asphalts are:

(a) Packaging: Due to the thermoplastic nature, the discrete elements of refined asphalts flow, and this problem increases with temperature.

Further, the bitumen content in the refined asphalts causes the bitumen on the surface of the discrete elements of the refined asphalts to easily coalesce. It is this coalescent problem which prevents refined asphalts from being packaged in paper or plastic or fabric bags, but the TLA is packaged in hardboard kegs coated with silicone, and the VLA is packaged in wooden barrels coated with a releasing agent, each in bulk-form containing 250 kg.

This filling process of kegs or barrels is usually done at 163° C., and as there is shrinkage of the refined asphalts on cooling, the kegs or barrels have to be topped-up during a second filling process, thus adding to the refined asphalt's many handling problems.

The coated keg and barrel containers cause environmental problems when disposed, and are costly to the end-user.

(b) Usage: TLA and VLA have been successfully used as modifiers to significantly improve the performance of refinery bitumen in road-paving mixes for many decades.

The bulk-form of packaging TLA and VLA, each weighing 250 kg, cannot be easily transported via the conveyor belt directly to the drum/pug-mill in conventional road-paving equipment. If the bulk-form of 250 kg is broken into smaller pieces, these smaller pieces will continue to coalesce, or stick to the conveyor belts. The TLA and VLA are therefore difficult to handle. As the TLA or VLA cannot be transported via conveyor belts directly to the drum/pug-mill, the TLA or VLA, like other modifiers, must be separately blended with the refinery bitumen, and then the blend stored until being pumped to the drum/pug-mill for mixing with the aggregates. However, the transporting, storing and handling the 250 kg kegs until the refined asphalts are placed in the blending tank is the difficult and expensive venture—a problem not encountered with the other modifiers.

Further, as the density of the mineral matter in the TLA and VLA is higher than that of the contents of refinery bitumen, these mineral matters sediment when the TLA or the VLA is blended with refinery bitumen. Therefore, unlike the other modifiers, specialized heated tanks with stirrers are required to blend the TLA or VLA with the refinery bitumen, and these tanks are then used to store the blend until pumped to the drum/pug-mill for mixing with the aggregates. Further, despite the use of these stirrers, sedimentation still continues, and therefore these blends must be used within determined timeframes. These timeframes, usually about four hours, are determined by the grade of the bitumen used, the blend (i.e. asphalt:bitumen ratio), and the characteristics of the tanks and stirrers.

As most modifiers are in liquid form, these modifiers are easily blended with the refinery bitumen in tanks and the resulting blend is then pumped to the drum/pug-mill for mixing with the aggregates. However, whilst using specialized tanks to blend the refined asphalts with the refinery bitumen is an expensive venture (including extra heating costs), it is the handling of the solid 250 kg kegs/barrels prior which causes the major part of the total costs of the road-paving material.

For the above reasons, refined asphalts have never been used with the conventional road-paving equipment available worldwide. Handling the 250 kg kegs causes a significant part of the paving costs, and specialized equipment have to be used on every site refined asphalts are used, also adding to the cost to the end-user.

The problems therefore are to solve the thermoplastic and coalescent natures of the natural or refined asphalts.

The above characteristics (and problems) also apply to all natural asphalts (thermoplastic and coalescent in nature).

All the above characteristics (and problems) also apply to all refined asphalts.

### 6. The Problems of Using Natural and Refined Asphalts.

The two main problems with natural and refined asphalts are detailed in Section 3 Item 5 above.

The transporting, storing, handling and using of these asphalts in such forms are therefore costly to the end-users.

### 7. Processing and Using TLA or VLA.

TLA or VLA have been processed and used in the following manner throughout the decades:
(a) The TNA or VNA is mined;
(b) The water in the TNA (30% by weight) or the VNA (about 15% by weight) is removed using heat (i.e. using high-pressure steam at a temperature of 163° C.). Using an open flame causes flash problems;
(c) As the discrete elements flow and coalesce, TLA is packaged in silicone-coated hardboard kegs, and the VLA is packaged in wooden barrels coated with releasing agents;
(d) As shrinkage occurs on cooling, the kegs or wooden barrels have to be topped-up during a second filling process. In bulk-form of packaging, each keg or barrel contains 250 kg;
(e) The kegs or barrels are broken on-site to access the refined asphalts. This procedure is hazardous, and the kegs and barrels cause environmental problems when disposed. The refined asphalts are then broken into discrete and smaller sizes so as to transport these pieces into the blending tanks; and
(f) On every site TLA or VLA is used, specialized heated tanks with stirrers are required to keep the mineral matter in these refined asphalts in suspension when blended with refinery
(g) bitumen, and despite the use of stirrers, these blends must be used within timeframes determined by the grade of bitumen, the type of blend, and the characteristics of the tanks and stirrers—this timeframe is usually about four hours.

A flowchart of the production and use of TLA or VLA is therefore as follows:
Mining→water removed using steam at 163° C.→filled in coated kegs or wooden barrels→topped up (second filling)→used with specialized heated tanks with stirrers.

8. The Marketing of TLA and VLA.

(a) Despite all of the above problems, Trinidad Lake Asphalt (i.e. TLA) has been successfully used as a road-paving material since the 1880s. From 1890 to 1969, about twelve million metric tons of TLA have been used as a road-paving material, with an average of 143,000 metric tons/year. A significant part of these sales were packaged in coated kegs. The TLA is used as a modifier to enhance the performance of the refinery bitumen when used for road-paving. When TLA is blended with any refinery bitumen, the resulting binder gives superior performance as a road-paving material. For this reason, TLA is known worldwide as one of the premium modifiers available anywhere, having gained decades of goodwill as a successful modifier of refinery bitumen for road-paving. Examples of use could be found on the George Washington Bridge, as well as on the runways at the LaGuardia and JFK Airports in New York City, and at Terminal 3 of the Beijing Capital Airport, which was paved with TLA as a modifier for the 2008 Summer Olympics.

Kegged-TLA continues to be produced and marketed today. However, because of the problems detailed, present annual volumes are much lower than those from pre-1969.

(b) Further, during the period from 1885 to 1934, over one million tons of Venezuela Natural Asphalt were mined and exported to South Amboy, N.J., USA, where the water in the natural asphalt (i.e. VNA) was removed, and then the VLA used as a modifier of refinery bitumen, producing road-paving mixes which were used for paving in the east coast of the USA, including the cities like New York, New Jersey, Philadelphia and Washington D.C.

VNA has not been mined since 1934.

(c) Both TLA and VLA have decades of goodwill of successfully modifying refinery bitumen, increasing the performance of the bitumen. Therefore the performances of TLA and

(d) VLA over the decades are the standards to be achieved by all the processed asphalts in this patent, and in order to gain TLA's and VLA's goodwill, the processed asphalts must have no additive (i.e. no water as an additive), thus ensuring that processed asphalts would be the same material as the refined asphalts, hereby acting and performing as good as the refined asphalts.

9. Another Attempt to Produce Pelletized TLA.

There have been attempts (by others) to form pellets from TLA. In one attempt, the water-content of the TNA is first removed (Section 3 Item 7) to form the (refined) TLA. Using the refined asphalt as the base, pellets of TLA are then formed using a pelletized machine, and these are then coated with a powder (some percentage of the total weight of the TLA) to cover the pellets so that coalescing would not occur. The pellets are then packaged in fabric bags. This process does not change the TLA's characteristics of flowing and coalescing, and the mineral matter in the TLA still sediments when blended with refinery bitumen. However, by using small pellets, the flowing problem with TLA is minimized so that the TLA could be handled and used. The coalescent problem is “solved” by coating the pellets of the TLA with the powder. Finally, the pellets of TLA could either be conveyed to the specialized tanks for blending with refinery bitumen (saving the costs of handling the kegged TLA, but the sedimenting problem continues), or the pellets of TLA could be conveyed directly to the drum/pug-mill in conventional road-paving equipment (no need to separately blend the TLA with the refinery bitumen, so TLA's sedimenting problem would not be occurring).

However, the coalescent problem returns if or when the powder falls off the pellets during transport, storage and usage. Further, despite the use of the powder to cover the pellets, the pellets still adhere with increased compaction (i.e. increased pressure caused during storage, transport and use). Therefore the coalescent problem is not fully solved. As the powder used to coat the pellets is not removed prior to the TLA being used in the road-paving mix, the powder forms a part of the final road-paving mix. Therefore, the powder-coated TLA used in the mix is not 100% pure TLA. The powder-coated TLA consequently cannot gain the decades of TLA's goodwill, especially since the powder-coated TLA do not have a performance record like the kegged TLA.

10. Previous Technologies.

There are other technologies which addressed some of the problems detailed in Section 3 Items 5 and 6 above by using TNA as the starting base product (i.e. instead of using the refined asphalt as the base, as show in Section 3 Item 9 above). In these technologies:

(a) Stabilizers (such as clay or silica or others) are mixed with the natural asphalt (i.e. the TNA) using high shear mixers which add heat during the action, thereby increasing the melting point of the material;

(b) Elevated temperatures up to and between 160 and 200° C. are reached during the processing;

(c) Other stabilizers are sometimes also used with reactions to increase the surface tension around the pellets of TLA, so that the pellets do not coalesce; and

(d) The powders and pellets of TLA do not coalesce, are packaged in plastic bags, and could be conveyed directly to the drum/pug-mill in conventional road-paving equipment.

However, as stabilizers are used to produce the powders and pellets of TLA, this processed TLA is not the same material as TLA (i.e. not 100% pure TLA), and therefore lose the decades of goodwill with TLA as a road-paving material, especially since the powders and pellets of TLA do not have a performance record like the kegged TLA.

11. The Solutions.

TLA is a proven modifier, increasing the performance of refinery bitumen as a road-paving material for many decades. Likewise, the same is true of VLA for a few decades, and of NLA for a lesser duration.

However, natural and refined asphalts have problems of flowing, coalescing (i.e. packaging), and using (i.e. requiring specialized equipment), etc., thus making these asphalts not as cost effective as the other modifiers.

As a result, many attempts have been made to solve the above problems by marrying these natural or refined asphalts with additives (like a powder) and/or stabilizers (such as silica) which form part of the final road paving mix, therefore losing the decades of goodwill of successfully using TLA and VLA as modifiers for road-paving, and in many cases, the performance with the modifiers has been adversely affected by using these additives and stabilizers.

The solutions addressed in this patent are therefore as follows:

Either, with no additive, processing the natural asphalts so that the characteristics of these asphalts would be changed so that the discrete elements do not flow or coalesce, the sedimentation rate of the mineral matters when blended with refinery bitumen are reduced, and the processed asphalts could be used on conventional road-paving equipment—so both the flowing and coalescing problems would be solved, and the sedimenting problem would be either minimized, or would no longer caused to be a problem, or

Or using water as the only additive, processing the natural or/and refined asphalts so that after the additive have been removed, the characteristics of these asphalts would be changed, the discrete elements do not flow or coalesce, the sedimentation rate of the mineral matters when blended with refinery bitumen are reduced, and the processed asphalts could be used on conventional road-paving equipment—so both the flowing and coalescing problems would be solved, and the sedimenting problem would be either minimized, or would no longer caused to be a problem.

In all these two solutions above, the processed asphalts would be packaged in paper or plastic or fabric bags of various sizes, would be a 100% pure version of the refined asphalt, devoid of additives, and the performances with the processed asphalts would be as good as, and sometimes better, than those with the refined asphalts.

12. Statement of the Field of Endeavor.

Two new methods to process natural asphalts, like those found in the deposits at La Brea, Trinidad, West Indies, or at Guanoco, Sucre State, Venezuela, or elsewhere in the world, producing powders or pellets which contain no additive, (i.e. the additive—water, if and when used, is removed during the final process), the powders and pellets are not thermoplastic nor coalesce, could be used with conventional road-paving equipment (whether directly on the drum/pug-mill, or by blending with refinery bitumen), the processed asphalts perform as good as with the refined asphalt, is cost-effective, and gains the decades of goodwill of successfully using TLA or VLA or NLA as a road-paving modifier.

### BRIEF SU MARY OF THE INVENTION

1. Statement of the Object of the Invention.

This patent covers the following:

(a) The natural asphalts are processed with or without water as the additive, so that the final processed asphalts are in powder and pelletized forms which are not thermoplastic nor coalescence in nature; and

(b) The natural or refined asphalts are processed with water as the only additive, the water (natural water content—see Section 3 Item, and the additive) are then removed so that the final processed asphalts are devoid of this natural water content and additive, are in powder and pelletized forms, and are not thermoplastic nor coalescence in nature.

All the processed asphalts produced by methods (a) and (b) above could be packaged in paper or plastic or fabric bags, and could be used with conventional road-paving equipment. When used with aggregates, the mix would perform at least as good as with the refined asphalts, or better.

Also, the rate of sedimentation of the mineral matter in the processed asphalt when blended with refinery bitumen would be significantly lower than the rate of sedimentation when the refined asphalts are blended with refinery bitumen, thereby increasing the time-window of the use of the processed asphalt-refinery bitumen blend significantly higher than the four hours allowed with TLA or VLA when used on specialized heated tanks with stirrers.

2. The Two Methods.

This patent details the two methods to process natural and refined asphalts, solving the problems associated with the natural and refined asphalts' thermoplastic and coalescent nature. These methods produce processed asphalts which are user-friendly and cost-effective.

Section 3 Items 5 and 6 details the problems of transporting, storing, handling and using natural and refined asphalts which are thermoplastic and coalescent in nature.

Section 3 Item 7 shows how TLA or VLA is presently produced, giving a flowchart of its production and use.

Section 3 Items 9 and 10 show other ways of attempting to solve the problems caused by the thermoplastic and coalescent nature of natural and refined asphalts.

(a) Method One: With or without Additive.

In this method, the natural asphalt is used as the base product.

This method is as follows:

(i) The natural asphalt (i.e. TNA or VNA or NNA), with its natural water content (see Section 3 Item 3 above), is mined, and then crushed/extruded/pelletized/blender/mill/and others ways of making into smaller pieces (all these possible options are hereby called ‘crushed’), with or without water as the additive, into pelletized or powdered forms. The use of this water as an additive would help the crushing process, and is only used as surface water;

(ii) The crushed natural asphalt, with the natural water content, with or without the surface water as an additive, is then either dried with hot air at temperatures under 163° C., or dried with other possible methods under 163° C., or allowed to dry in the atmosphere, or allowed to dry in any other method;

(iii) The resulting powder or pellet processed asphalt (i.e. pTLA or pVLA or pNLA) are then packaged in paper or plastic or fabric bags of various sizes;

(iv) Water as an additive may or may not be used during the crushing process;

(v) The discrete elements of powders or pellets are not thermoplastic or coalescent in nature;

(vi) The processed asphalts (i.e. pTLA or pVLA or pNLA) of powders or pellets are then used on conventional road-paving equipment, transporting the content of the bags via conveyor belts either directly to the drum/pug-mill for mixing with the refinery bitumen and the aggregates, or to the blending tank in conventional road-paving equipment where the refinery bitumen and modifier are blended, and then pumped to the drum/pug-mill for mixing;

(vii) If plastic bags are used, these bags could be thrown into the mix (mixed with the aggregates or blended with the refinery bitumen), and do not adversely affect the performance of the final road-paving mix; and

(viii) The processed asphalts could then be used without any environmental problems to dispose of the packaging, and without any extra on-site specialized tanks with stirrers.

The flowchart to produce and use the processed asphalt (i.e. pTLA or pVLA or pNLA) is therefore as follows:

Mining→crushing→drying→packaging→used with conventional road-paving equipment.

The stages from (i) to (viii) above could be repeated with other natural asphalts available worldwide which are thermoplastic and coalescent in nature, to produce powders and pellets of pNLA which are of the same material as NLA, and when used, act as the same material as NLA, performing just as good.

(b) Method Two: With water as the only additive.

In this method, the natural or refined asphalts are used as the base product.

This method is as follows:

Option One: The natural asphalt, with its natural water content (see Section 3 Item 3) is mined, and then crushed/extruded/pelletized/blender/mill/and others ways of making into smaller pieces (all these possible options are hereby called ‘crushed’), with or without water as an additive to help the crushing process, into discrete elements of sizes, or

Option Two: after the refined asphalt is produced by removing the water content of the natural asphalt using high-pressure steam at 163° C. (Section 3 Item 7), the refined asphalt is then crushed/extruded/pelletized/blender/mill/and others ways of making into smaller pieces (all these possible options are hereby also called ‘crushed’), with or without water as an additive to help the crushing process, into discrete elements of sizes;

(ii) Water is added to the resulting discrete elements from Option One and/or Two, the combination is then mixed in a pulverizer/variable speed blender/mill/or other machines which causes mixing/crushing/blending/pelletized/milling and other ways of making the discrete elements into smaller pieces (all these possible options are hereby called ‘blender’), with no added heat. Pellets are produced on the ‘blender’ using slower crushing rates/lower speeds/shorter milling periods/etc., or powders are produced on the ‘blender’ using higher crushing rates/higher speeds/longer milling periods/etc., or by other methods. The timeframe of the blending would be mainly determined by the asphalt:water ratio (i.e. natural asphalt:water additive ratio), and the required size of the final discrete element;

(iii) After the completion of the ‘blending’ process, most of the water which was added in the crushing (if used) and the blending processes are then drained and stored for re-use;

The resulting mix of either the natural asphalt (with natural water content—see Section 3 Item 3) from Option One, and/or the refined asphalt from Option Two, together with surface water (from the additive), is then dried with either hot air at temperatures under 163° C., or dried using other possible methods under 163° C., or simply allowed to dry in the atmosphere, or allowed to dry in any other method;

(iv) The powders or pellets of the processed asphalts are then packaged in paper or plastic or fabric bags of various sizes. The processed asphalts (i.e. pTLA or pVLA or pNLA) are then used on conventional road-paving equipment, transporting the content of the bags via conveyor belts either directly to the drum/pug-mill for mixing with the refinery bitumen and the aggregates, or to the blending tank in conventional road-paving equipment where the refinery bitumen and modifier are blended, and then pumped to the drum/pug-mill for mixing;

(v) The only additive used is therefore the added water, and this is either drained, or removed by drying—so the additive form not part of the final processed asphalts;

(vi) If plastic bags are used, these bags could be thrown into the mix (mixed with the bitumen and aggregates in the drum/pug-mill, or blended with the refinery bitumen in the blending tank), and do not adversely affect the performance of the final road-paving mix;

(vii) These processed asphalts could be used to produce both hot or cold mixes for road-paving; and

(viii) The processed asphalts could then be used without any environmental problems to dispose of the packaging, and without any extra on-site specialized tanks with stirrers.

The flowchart to produce and use of the processed asphalts (i.e. pTLA or pVLA or pNLA) are therefore as follows:

Mining and/or refining→adding water→blending→remaining water drained for re-use→drying→packaging→used with conventional road-paving equipment.

The stages from (i) to (viii) above could be repeated with other natural asphalts available worldwide (thermoplastic and coalescent in nature), to produce powders and pellets of pNLA which are of the same material as NLA, and have the similar characteristics of pTLA or pVLA, performing just as good.

### BRIEF DESCRIPTION OF THE SEVERAL VIEWS OF THE DRAWING

Not Applicable.

### DETAILED DESCRIPTION OF THE INVENTION

1. The Two Methods.

(a) Method One: With or without Additive.

Section 4 Item 2(a) shows the flowchart of how these processed asphalts are produced and used.

The process is detailed in Section 4 Item 2 (a).

In this method, the natural asphalt is used as the base product.

The natural asphalt (i.e. TNA or VNA or NNA), with its natural water content (see Section 3 Item 3), is mined, and then crushed/extruded/pelletized/blender/mill/and others ways of making smaller pieces (hereby all possible options to crushing/breaking/making smaller/etc. are all hereby called ‘crushed’), with or without water as an additive to help the crushing process, into pellet or powder sizes.

The crushed natural asphalt, with the natural water content, with or without the surface water as an additive, is then either dried with hot air at temperatures under 163° C., or dried with other possible methods under 163° C., or allowed to dry in the atmosphere, or allowed to dry with any other method.

The resulting processed asphalt (i.e. pTLA or pVLA or pNLA) powders or pellets are then packaged in paper or plastic or fabric bags of various sizes. The discrete elements of pellets are not thermoplastic or coalescent in nature, and are used on conventional road-paving equipment, transporting the content of the bags via conveyor belts either directly to the drum/pug-mill for mixing with the refinery bitumen and aggregates, or to the blending tank where the refinery bitumen and modifier are blended, and then pumped to the drum/pug-mill for mixing with the aggregates.

If plastic bags are used as containers, these plastic bags could be thrown into the mix (with the aggregates in the drum/pug-mill, or with the refinery bitumen in the blending tank), and do not adversely affect the performance of the final road-paving mix.

Further, the actions of the process change the characteristics of the natural asphalts, resulting in powders and pellets which have more user-friendly characteristics than those of the natural or refined asphalts. Also, the rate of sedimentation of the mineral matter in the processed asphalt when blended with refinery bitumen is significantly lower than the rate of sedimentation when the refined asphalts are blended with refinery bitumen, thereby increasing the time-window of the use of the processed asphalt-refinery bitumen blend significantly higher than the four hours allowed with TLA or VLA when used on specialized heated tanks with stirrers.

The processed asphalts could then be used without any environmental problems to dispose of the packaging, and without any extra on-site specialized tanks with stirrers.

The pTLA or pVLA or pVLA is the same material as TLA or VLA or NLA respectively, and acts and performs just as good, and sometimes better.

The processed asphalts are user-friendly, cost-effective to the end-user, and the decades of goodwill of successfully using TLA and VLA as a road-paving material could be gained by these powders and pellets produced and used with this new method.

In the powdered form, the pTLA or pVLA or pNLA could also be used to produce the non-paving options, like as a base for coatings, epoxies, chip-board, etc.

(b) Method Two: With Water as the Only Additive.

Section 4 Item 2(b) shows the flowchart of how these processed asphalts are produced and used.

The process is detailed in Section 4 Item 2 (b).

In this method, either the natural asphalts, or the refined asphalts, could be used as the base to produce processed asphalts.

In this method, the natural and/or refined asphalts are firstly crushed (see Section 4 Item 2(b)), with or without water as an additive to help the crushing process. Water only is then added to the crushed natural and/or refined asphalts, and the resulting combination is then mixed using a ‘blender’ (see Section 4 Item 2(a)), without added heat, to produce powders or pellets. Pellets are produced on the ‘blender’ by using slower crushing rates/lower speeds/shorter milling times/etc., or powders are produced on the ‘blender’ by using higher crushing rates/higher speeds/longer milling times/etc., or by other methods. The temperature increase during the blending process would be dependent on the natural asphalt:water ratio (i.e. the higher the water ratio, the lower the temperature increase)—the temperature increase could only be less than 10° C. After the blending, the added water is drained and stored for re-use. The resulting mix of natural asphalt and water is then dried with either hot air at temperatures under 163° C., or dried with other possible methods under 163° C., or simply allowed to dry in the atmosphere, or allowed to dry with any other method;

The resulting powders and pellets of processed asphalt of pTLA or pVLA or pNLA are then packaged in paper or plastic or fabric bags of various sizes, and then used on conventional road-paving equipment, transporting the pellets via conveyor belts either directly to the drum/pug-mill for mixing with the refinery bitumen and the aggregates, or to the blending tank where the refinery bitumen and modifier could be blended, and the resulting blend is then pumped to the drum/pug-mill for mixing.

When packaged in plastic bags, the pellets and the plastic bags could be conveyed either to the drum/pug-mill, or to the blending tank, as the plastic bags do not adversely affect the performance of the modifier.

Water is the only additive in the process, and this is either removed by draining, or by drying. Therefore, no additive is used in the processed asphalts.

Further, the actions of the process change the characteristics of the natural and refined asphalts, resulting in powders and pellets of processed asphalts which have more user-friendly characteristics than those of the natural or refined asphalts, in that these powders and pellets do not flow or coalesce. Also, the rate of sedimentation of the mineral matter in the processed asphalt when blended with refinery bitumen is significantly lower than the rate of sedimentation when the refined asphalts are blended with refinery bitumen, thereby increasing the time-window of the use of the processed asphalt-refinery bitumen blend significantly higher than the four hours allowed with TLA or VLA when used on specialized heated tanks with stirrers.

Since the processed asphalts have no additive, the pTLA or pVLA or pNLA produced are all the same material as the TLA or VLA or NLA respectively. In addition, the blends of the processed asphalts with refinery bitumen perform as good as, and sometimes better than, similar blends with the TLA or VLA or NLA respectively. This shows that the powders and pellets products by this new method performs as good as the kegged or barreled products produced for decades by the original method (Section 3 Item 7), and pTLA or pVLA or pNLA is easier to handle and use, and is more cost-effective. The decades of goodwill of successfully using TLA and VLA as a road-paving material could therefore be transferred to the powders and pellets produced with this new method.

In the powdered form, the pTLA or pVLA or pNLA could also be used to produce the non-paving options, like as a base for coatings, epoxies, chip-board, etc.

(2) The Differences and Improvements.

The Methods detailed in this patent are new in that, amongst others:

(a) Section 3 Item 7 shows an attempt by others to package, transport, storage and handle TLA. In this attempt, the water content of the natural asphalt of TNA is removed to form a refined asphalt of TLA which is packaged in bulk-form in kegs and barrels, each carrying 250 kg, making it a hazard to handle, an environment problem to discard the containers, and with the same user-unfriendly characteristics (the discrete elements flowing and coalescing, cannot be used on conventional equipment, etc.). However, in all these new Methods in this patent, the processed asphalts are user-friendly (no coalescing, used on conventional equipment), are packaged in paper or paper or fabric bags of various sizes, and easier to handle. The plastic bags could be thrown with the pellet into the drum/pug-mill in the conventional equipment, and the paper and fabric bags form no environmental problem to discard.

(b) In this attempt by others in Section 3 Item 9, a powder is used to stop the pellets of TLA from coalescing, and if or when the powder falls off the pellets during transport, storage or handling, or when the powdered pellets are compacted, the coalescent problem re-occurs. Further, the powder used to coat the pellets forms a part of the final road-paving mix. Therefore, the powder-coated TLA used is not the same material as TLA, thereby losing the decades of goodwill of TLA as a modifier for road-paving.

(c) Section 3 Item 10 shows an attempt by others to form pellets which do not coalesce. This attempt is different from Method Two in this patent in that, in Method Two: (i) no high shear mixer is required to reduce the temperature of the action but it is rather the added water which reduces the friction to lower the temperature of the mixture, (ii) the equipment used in these new Methods One and Two is a pulverizer/variable speed blender/mill/or other machines which causes mixing/crushing/blending/pelletized/milling and other ways of making the discrete elements into smaller pieces (see Section 4 Item 2(a)), (iii) the temperature of the TNA with water does not go up to between 160 to 200° C., but only goes up by about 10° C. in Method Two, showing that in Method Two, the process is not temperature dependent, and that the water used as an additive is only used as surface water, (iv) no stabilizers (like clay or silica or others) are used to increase the melting point, and (v) no stabilizers form a part of the final road-paving mix. In Method Two, the additive used (i.e. water) does not form a part of the processed asphalt, and the pTLA or pVLA or pNLA are respectively the same materials as TLA or VLA or NLA, without any stabilizers.

(d) In Method One and Two, the rate of the sedimentation of the mineral matters in the powders and pellets of pTLA or pVLA or pNLA when blended with refinery bitumen is slowed that the corresponding rates of sedimentation with TLA or VLA or NLA when blended with refinery bitumen.

(e) In order to use refined asphalts in other processes, specialized heated tanks with stirrers are required on-site, but in all these Methods, the pellets and powders produced could be used with conventional road-paving equipment.

(f) The powdered pTLA or pVLA or pNLA could be used for non-paving options.

(g) In Method One, no additive could be used.

In Method Two, it is the action of the process which changes the characteristics of the natural and refined asphalt, and not any secondary action, as is done by others (see Section 3 Item 10);

(h) This process applies to all natural asphalts, including TNA and VNA and NNA, which have thermoplastic and coalescent characteristics; and

(i) This process applies to all refined asphalts, including TLA and VLA and NLA, which have thermoplastic and coalescent characteristics.

1. That all these processed asphalts, either processed with no additive, or processed with water as the only additive, after dried, are the same material as the refined asphalts, could gain the decades of goodwill from the refined asphalts, could be used on conventional road-paving equipment using no specialized heated tanks with stirrers, and these blends would perform as good as, and sometimes better than, the blends with the refined asphalts;

2. That these processed asphalts are packaged in paper or plastic or fabric bags, of various sizes, up to 1000 kg and higher, could be stacked for transport and storage, and then could be carried via conveyor belts directly to the drum/pug-mill on conventional road-paving equipment, or carried directly to the blending tank, and that the plastic bags could be sent directly to the road-paving drum/pug-mill, or the blending tank, giving no adverse effect in performance, the paper and fabric bags could be disposed with no environmental problem, thereby making the processed asphalts more-friendly than the refined asphalts, giving significant savings to the end-user; and

3. That heat is used in the processing of the natural asphalt to remove of the water-content in the natural asphalt, and/or the surface water used to process the natural and refined asphalts, and that the characteristics of the natural and refined asphalts used in these processes are changed so that the discrete elements of the processed asphalts do not flow or coalesce, and that the rate of the sedimentation of the mineral matter in the processed asphalts when blended with refinery bitumen is significantly lower than the similar blends with refined asphalts, and that these processed asphalts could be used, amongst others, as cold blends for road-paving, as a base for epoxies, industrial coatings, tires, and even for skin care.
